(19) United States
(12) Patent Application Publication
(10) Pub. No.: US 2004/0103403 A1
(43) Pub. Date: May 27, 2004

(54) Embedded programming language to facilitate programming of an information packet processing unit

(76) Inventor: Viswanath Nanjundiah, Fremont, CA (US)

Correspondence Address: BUCKLEY, MASCHOFF, TALWALKAR LLC, 5 ELM STREET, NEW CANAAN, CT, 06840, US

(21) Appl. No.: 10/304,877

(22) Filed: Nov. 26, 2002

(51) Int. Cl. G06F 9/44

(52) U.S. Cl. 717/136; 717/143; 717/114

(57) ABSTRACT

According to some embodiments, an embedded programming language is provided to facilitate programming of an information packet processing unit.

### BACKGROUND

A network processor may facilitate an exchange of information via one or more networks. For example, a network processor may receive, process, and transmit packets of information. Some network processors include: (i) a control unit to process the packets in the control plane and (ii) a number of high-speed information packet processing units (e.g., microengines) to process the packets in the data plane. For example, an information packet processing unit may parse headers associated with information packets (e.g., to determine how each information packet should be processed and/or transmitted).

It is known that software for an information packet processing unit can be developed directly in assembly language (e.g., microcode). For example, a programmer might write and debug software using assembly language code.

It is also known that such software can be developed using a modified version of a standard-programming language, such as a modified version of a C programming language. The modified version may comprise, for example, a subset of the American National Standards Institute (ANSI)/Intemational Standards Organization (ISO)/International Engineering Consortium (IEC) standard entitled “Programming Languages—C,” Document Number 9899 (Dec. 1, 1999) along with some additional hardware intrinsic functions (e.g., functions associated with the information packet processing unit). Typically, intrinsic functions are provided to access hardware features.

Developing software using assembly language (or similar instructions), however, can be a slow and expensive process. For example, writing software in assembly language is tedious and may result in errors. Moreover, debugging the software can be difficult because it is not easy to read and understand assembly language code.

### BRIEF DESCRIPTION OF THE DRAWINGS

FIG. 1 is a block diagram of a network processor according to some embodiments.

FIG. 2 illustrates programming statements according to some embodiments.

FIG. 3 is an information flow diagram in accordance with an example of the present invention.

FIG. 4 is a flow chart of a method that may be performed by a compiler according to some embodiments.

FIG. 5 is a flow chart of a programming method according to some embodiments.

### DETAILED DESCRIPTION

Some embodiments described herein are associated with a “network processor.” As used herein, the phrase “network processor” may refer to, for example, a device that facilitates an exchange of information via a network, such as a Local Area Network (LAN), or a Wide Area Network (WAN). By way of example, a network processor might facilitate an exchange of information packets in accordance with the Fast Ethernet LAN transmission standard 802.3-2002® published by the Institute of Electrical and Electronics Engineers (IEEE). Moreover, a network processor may be associated with a switch, a router (e.g., an edge router), a layer 3 forwarder, and/or protocol conversion. Examples of network processors include those in the INTEL® IXP 1200 family of network processors.

Network Processor

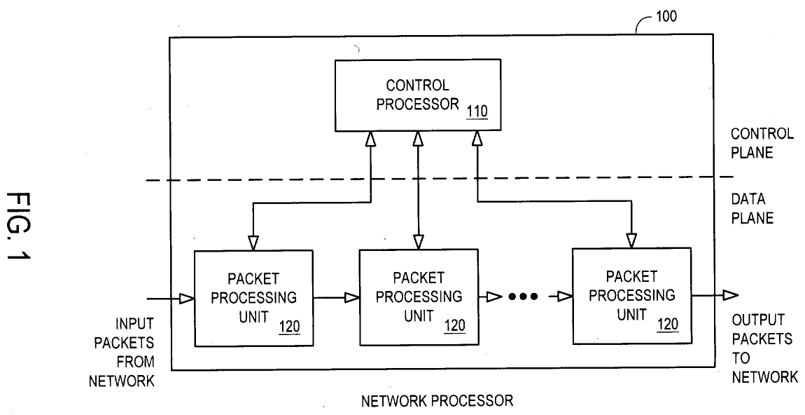

FIG. 1 is a block diagram of a network processor 100 according to some embodiments. The network processor 100 includes a number of information packet processing units 120 that perform information packet processing in the data plane. For example, the information packet processing units 120 may comprise multi-threaded, Reduced Instruction Set Computer (RISC) microengines adapted to perform information packet processing.

Note that an information packet processing unit 120 may be unable to process a particular information packet. In this case, the information packet processing unit 120 may forward the information packet (referred to as an “exception packet”) to a control processor 110 for further processing. The control processor 110 may comprise, for example, a core Central Processing Unit (CPU) that can perform more intensive processing on the exception packet. By way of example, the control processor 110 may comprise an INTEL® StrongARM core CPU.

Note that different information packet processing units 120 may be programmed to perform different tasks. By way of example, one information packet processing unit 120 might receive input information packets from a network interface. Another information packet processing unit 120 might process the information packets, while still another one forwards output information packets to a network interface. That is, the operation of the network device 100 may be determined at least in part by code that is loaded into, and executed by, the information processing units 120.

Information Processing Unit Programming

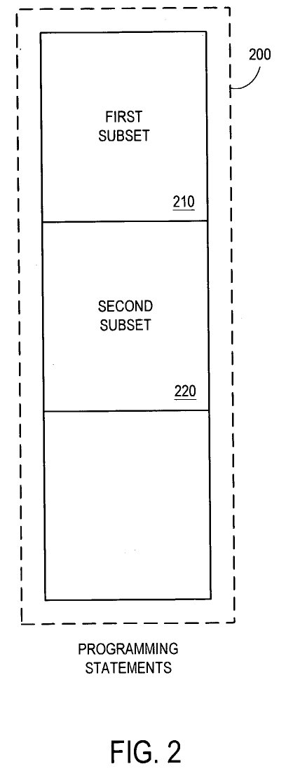

FIG. 2 illustrates programming statements 200 (e.g., source code) that may be associated with an information processing unit 120 according to some embodiments. The programming statements 200 may be stored, for example in memory or on a storage medium.

A first subset 210 of the programming statements 200 includes statements that are defined in a standard programming language. The standard programming language may be any high level programming language. The standard programming language may be, for example, a C programming language such as the C++ programming language as defined by the ANSI/ISO/IEC standard entitled “Programming Languages—C++,” Document Number 14822 (Sep. 15, 1998).

A second subset 220 of the programming statements includes at least one statement that is defined in a programming language adapted to facilitate programming of an information packet processing unit 120 (i.e., instead of a standard programming language). For example, the second subset 220 may be embedded in the programming statements 200 (e.g., between standard C programming statements).

The programming statements in the second subset 220 define how an information packet processing unit 120 will operate. Moreover, the programming statements may be defined in a language that is more easily written and read by a programmer as compared to assembly language or microcode. The programming statements may be associated with, for example, the INTEL® Network Classification Language (NCL).

By way of example, a programming statement in the second subset 220 might be associated with information packet header parsing and/or exception packet identification functions. Similarly, a programming statement might define how an information packet processing unit 120 should receive, process, and/or transmit an information packet.

Although a first subset 210 and a second subset 220 are illustrated in FIG. 2, any number of subsets may be included in the programming statements 200. According to some embodiments, the boundaries of the second subset are associated with a begin indication (e.g., “Begin_NCL”) and/or an end indication (e.g., “End_NCL”). The following is an example of an NCL instruction embedded in standard C programming statements:

| | |
|---|---|
| while(1) | // receive packets |

{

// make sure packets are available at receive port
rcv_rdy = 0;
//read packet header into local microengine registers
receive_pkt(destination);
// perform packet header processing
Begin_NCL

// include statements to
// define IP protocol using NCL
rule filter_packet {ip & & ip.dst = =
BROADCAST_ADDR} {drop_packet( )}

End_NCL
if (exception_packet)

send_packet_to_cp( ); // send to control plane

else if (to be dropped)

drop_packet( );

else

xfer_to_sdram; //transfer to sdram

// signal another thread for further processing or to transmit
packet_count++; // increment packet count

} // while - go to start of receive loop

In particular, these programming statements define how an information packet processing unit 120 should receive, process, and transmit information packets. Note that standard C programming statements are used, for example, to make sure information packets are available at a receive port and to read an information packet header into local registers. Moreover, the information packet header processing is defined using a programming language adapted to facilitate programming of an information packet processing unit 120 (e.g., NCL is used to define protocol IP protocol). Standard C programming statements are then used to perform exception packet processing and to transfer information to Synchronous Dynamic Random Access Memory (SDRAM).

Information Processing Unit Code Generation

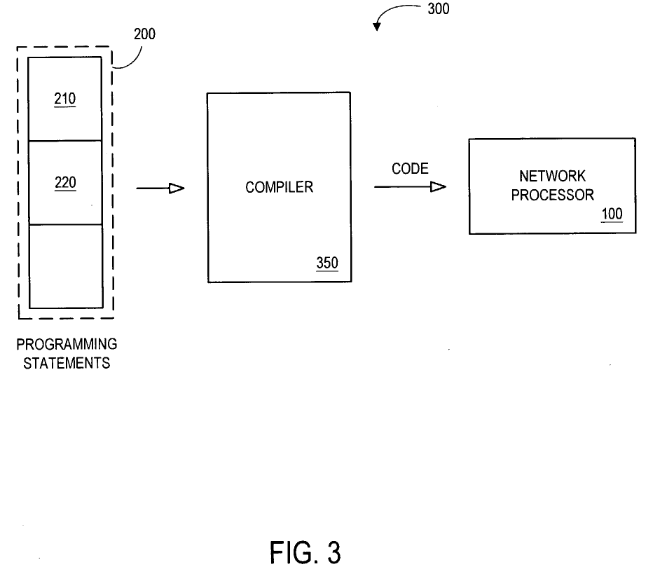

FIG. 3 is an information flow diagram 300 in accordance with an example of the present invention. In particular, a set of programming statements 200 is provided to a compiler 350. The set of programming statements 200 includes a first subset of statements 210 defined in a standard programming language and a second subset of statements 220 defined in a programming language adapted to facilitate programming of a packet processing unit 120 (e.g., NCL). The compiler 350 may comprise, for example, a software application or a hardware device. Moreover, the compiler 350 may receive the programming statements from memory, a magnetic medium, or another software application or hardware device.

The compiler 350 translates the programming statements 200 into code (e.g., assembly language code). For example, the compiler 350 may generate code that can be executed by an information packet processing unit 120 in a network processor 100. In particular, the first subset of statements 210 may be translated in a standard way (e.g., the way that typical C programming statements are typically compiled). When the compiler 350 identifies the second subset of statements 220 (e.g., via “Begin_NCL” and “End_NCL” programming statements), however, a non-standard translation may be needed to generate the appropriate code.

After translating the programming statements 200, the compiler 350 may output the appropriate code (e.g., to memory, a magnetic medium, or another software application or hardware device). Note that the code might also be linked as appropriate. The code may then be loaded into and executed by an information packet processing unit 120 in a network processor 100.

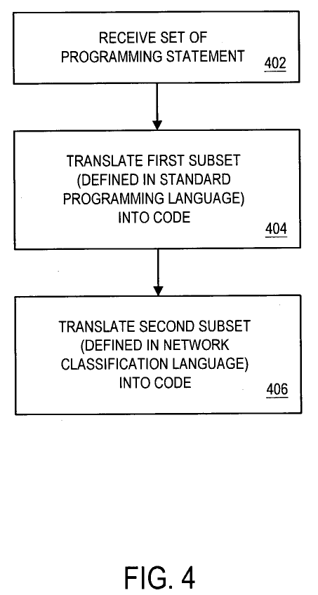

FIG. 4 is a flow chart of a method that may be performed by a compiler according to some embodiments. The flow charts described herein do not imply a fixed order to the actions, and embodiments may be practiced in any order that is practicable. The method may be associated with, for example, the compiler 350 illustrated in FIG. 3.

At 402, a set of programming statements is received. A first subset of the statements is then translated into code at 404, wherein statements in the first subset are defined in a standard programming language (e.g., a C programming language). At 406, a second subset of the statements is translated into code, wherein statements in the second subset are defined in a programming language adapted to facilitate programming of an information packet processing unit (e.g., NCL). According to some embodiments, the compiler 350 also provides code associated with the set of programming statements (e.g., to be loaded into and executed by a microengine).

Programming Method

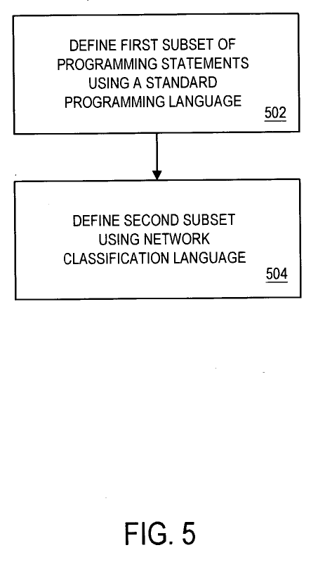

FIG. 5 is a flow chart of a programming method according to some embodiments. The method may be performed, for example, by a programmer who is defining how an information packet processing unit 120 should operate. At 502, he or she defines a first subset of programming statements using a standard programming language (e.g., the C programming language). At 504, the programmer defines a second subset of the programming statements using a programming language adapted to facilitate programming of an information packet processing unit (e.g., NCL). The programming statements may then be compiled (e.g., using a special C compiler adapted to also translate NCL programming statements), linked, and executed.

Thus, the use of assembly language (or similar instructions) when developing software for a network processor may be reduced. As a result, the development process (e.g., writing and debugging the software) may be improved.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although particular programming languages have been described herein (e.g., the C programming language and NCL), embodiments may be used with other programming languages. Moreover, although software or hardware have been described as performing various functions, such functions might be performed by either software or hardware (or a combination of software and hardware).

The several embodiments described herein are solely for the purpose of illustration. Persons skilled in the art will recognize from this description other embodiments may be practiced with modifications and alterations limited only by the claims.

What is claimed is:

1. A method, comprising:
receiving a set of programming statements;
translating a first subset of the statements into code, wherein statements in the first subset are defined in a standard programming language; and
translating a second subset of the statements into code, wherein statements in the second subset are defined in a programming language adapted to facilitate programming of an information packet processing unit.

2. The method of claim 1, wherein the standard programming language comprises a C programming language.

3. The method of claim 1, wherein the programming language adapted to facilitate programming of the information packet processing unit comprises a classification language.

4. The method of claim 1, wherein at least one of the statements in the second subset is associated with at least one of: (i) information packet header parsing, (ii) exception packet identification, (iii) information packet receipt, (iv) information packet transformation, and (v) information packet transmission.

5. The method of claim 4, wherein boundaries of the second subset are associated with at least one of a begin indication and an end indication.

6. The method of claim 1, wherein the code is associated with a network processor.

7. The method of claim 6, wherein the network processor includes a control processor and a plurality of information packet processing units.

8. The method of claim 7, wherein the control processor comprises a StrongARM core processor.

9. The method of claim 6, wherein the network processor is associated with at least one of: (i) Internet protocol information packets, (ii) Ethernet information packets, (iii) a local area network, (iv) a wide area network, (v) a switch, and (vi) a router.

10. The method of claim 1, wherein the information packet processing unit comprises a microengine.

11. The method of claim 10, wherein the microengine comprises a multi-threaded, RISC microengine adapted to perform information packet processing in a data plane.

12. The method of claim 1, further comprising:
providing code associated with the set of programming statements.

13. The method of claim 12, wherein the provided code is associated with at least one of: (i) assembly language, and (ii) microcode.

14. A medium storing instructions adapted to be executed by a processor to perform a method, said method comprising:
receiving a set of programming statements;
translating a first subset of the statements into code, wherein statements in the first subset are defined in a standard programming language; and
translating a second subset of the statements into code, wherein statements in the second subset are defined in a programming language adapted to facilitate programming of an information packet processing unit.

15. The medium of claim 14, wherein the standard programming language comprises a C programming language.

16. The medium of claim 14, wherein the code is associated with a network processor and the information packet processing unit comprises a microengine.

17. A medium storing a set of set of programming statements adapted to be translated into code, said set of programming statements including:
a first subset defined in a standard programming language; and
a second subset defined in a programming language adapted to facilitate programming of an information packet processing unit.

18. The medium of claim 17, wherein the standard programming language comprises a C programming language.

19. The medium of claim 17, wherein the code is associated with a network processor and the information packet processing unit comprises a microengine.

20. A method, comprising:
defining a first subset of programming statements using a standard programming language; and
defining a second subset of the programming statements using a programming language adapted to facilitate programming of an information packet processing unit.

21. The method of claim 20, further comprising:
arranging for the programming statements to be translated into code.

22. The medium of claim 21, wherein the code is associated with a network processor and the information packet processing unit comprises a microengine.

23. The medium of claim 20, wherein the standard programming language comprises a C programming language.
